(19) United States
(12) Patent Application Publication
(10) Pub. No.: US 2009/0305786 A1
(43) Pub. Date: Dec. 10, 2009

(54) INFRARED LIGHT BAR AND GAME DEVICE USING SAME

(75) Inventor: JEN-TSORNG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/344,649

(22) Filed: Dec. 29, 2008

(30) Foreign Application Priority Data
Jun. 5, 2008 (CN) 200810302037.4

(51) Int. Cl. G06F 17/00; F21V 7/00

(52) U.S. Cl. 463/37; 362/296.01

(57) ABSTRACT

An exemplary infrared light bar includes at least one light source for emitting infrared light, an elongated infrared light guide member, and a reflecting layer. The infrared light guide member includes at least one light incident surface for receiving the infrared light and a longitudinal side surface consisting of a covered portion and a plurality of exposed portions. The reflecting layer is formed on the entire covered portion of the longitudinal side surface for blocking the infrared light transmitting therethrough. The reflecting layer defines a plurality of spaced openings spatially corresponding to the exposed portions for allowing the infrared light to exit therefrom.

### BACKGROUND

1. Technical Field

The present invention relates to an infrared light bar and a game device using the infrared light bar.

2. Discussion of Related Art

With the development of telecontrol technology, more and more remote controllers adopt directly sensing the actions of a player to control a game device or game movements.

Currently, at least one remote controller is used in game device for players to control the game device. To get the precise position of players action, usually a light source module is placed adjacent to the display of the game device. The light source module includes a plurality of point light sources. The remote controller has a detector to receive the light beams emitted from the point light sources. When a player operates the remote controller, the light beams received by the detector are varying by the action of the player. By analyzing and processing the light beams that are received, the action of the player will be obtained, and action position of the player will be shown in the game. To exactly recognize and accurately locate for the detector, usually a plurality of point light sources is mounted in the light source module. Generally, a point light source includes an independent light source, such as an infrared light emitting diode. Each independent light source needs a chip to control the light source, so the cost will be expensive.

Therefore, what is needed is an infrared light bar and a game device using the infrared light bar capable of overcoming the described limitations.

### BRIEF DESCRIPTION OF THE DRAWINGS

Many aspects of the present infrared light bar can be better understood with reference to the following drawings. The components in the drawings are not necessarily to scale, the emphasis instead being placed upon clearly illustrating the principles of the present infrared light bar. Moreover, in the drawings, like reference numerals designate corresponding parts throughout the several views.

FIG. 1 is a schematic, isometric view of an infrared light bar in accordance with a first embodiment.

FIG. 2 is a schematic, isometric view of the infrared light bar of FIG. 1.

FIG. 3 is a schematic, isometric view of an infrared light bar in accordance with a second embodiment.

FIG. 4 is a schematic, isometric view of an infrared light bar in accordance with a third embodiment.

FIG. 5 is a schematic, isometric view of an infrared light bar in accordance with a fourth embodiment.

FIG. 6 is a schematic, isometric view of a game device in accordance with an exemplary embodiment.

### DETAILED DESCRIPTION OF EMBODIMENTS

Reference will now be made to the drawings to describe in detail of the exemplary embodiment of the infrared light bar and the game device.

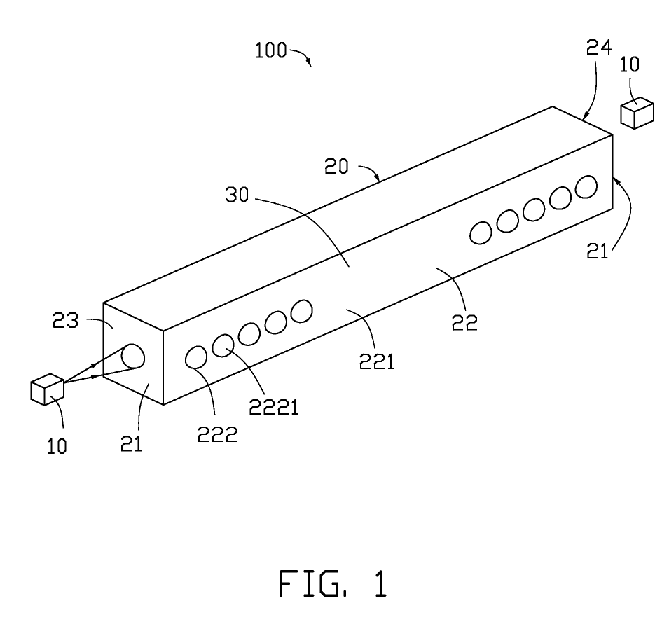

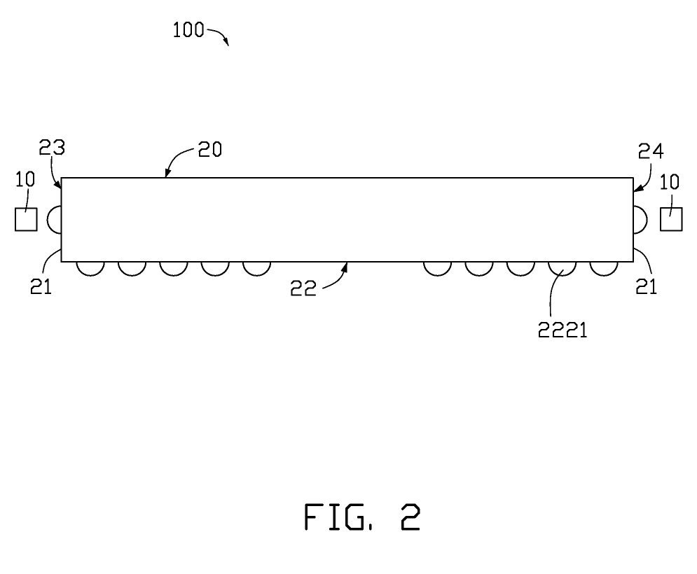

Referring to FIGS. 1 and 2, an infrared light bar 100, in accordance with a first embodiment, includes two light sources 10 for emitting infrared light, an elongated infrared light guide member 20 and a reflecting layer 30.

The light sources 10 are single color light sources and are disposed at opposite sides of the infrared light guide member 20. In the present embodiment, the light sources 10 are infrared light emitting diodes.

The infrared light guide member 20 includes two light incident surfaces 21 for receiving the infrared light and a longitudinal side surface 22 consisting of a covered portion 221 and a plurality of exposed portions 222. The infrared light guide member 20 includes a first end surface 23 and an opposing second end surface 24, and the longitudinal side surface 22 is connected between the first and the second end surfaces 23, 24. The first and the second end surfaces 23, 24 are light incident surfaces 21. The light sources 10 are arranged respectively at two ends of the infrared light guide member 20 facing the first end and the second end surfaces 23, 24. In the present embodiment, the infrared light guide member 20 is a rectangle. The exposed portions 222 are symmetrically arranged on the longitudinal side surface 22. A plurality of protrusions 2221 are formed on the exposed portions 222 of the longitudinal side surface 22. In the present embodiment, the protrusions 2221 are hemispheroidal protrusions. The protrusions 2221 each have a curved surface.

The reflective layer 30 is formed on the entire covered portion 221 of the longitudinal side surface 22 for blocking the infrared light transmitting therethrough. The reflecting layer 30 defines a plurality of spaced openings spatially corresponding to the exposed portions 222 for allowing the infrared light to exit therefrom. Therefore, the infrared light incident from the light incident surface 21 can only emit from the exposed portion 222 of the longitudinal side surface 22. The reflective layer 30 may be a reflective coating film coated on the covered portion 221 of the longitudinal side surface 22.

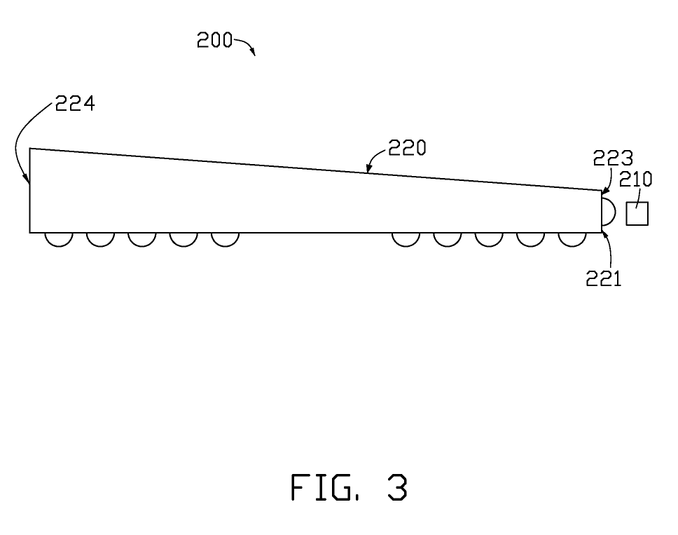

Referring to FIG. 3, an infrared light bar 200, in accordance with a second embodiment, has the similar structure with the infrared light bar 100 of the first embodiment except that the infrared light bar 200 only has one light source 210 arranged at one end of the infrared light guide member 220, and the structure of the infrared light guide member 220 is different with that of the infrared light guide member 20 of the first embodiment. In the present embodiment, the first end surface 223 is the light incident surface 221. The infrared light guide member 220 tapers from the second end surface 224 to the first end surface 223.

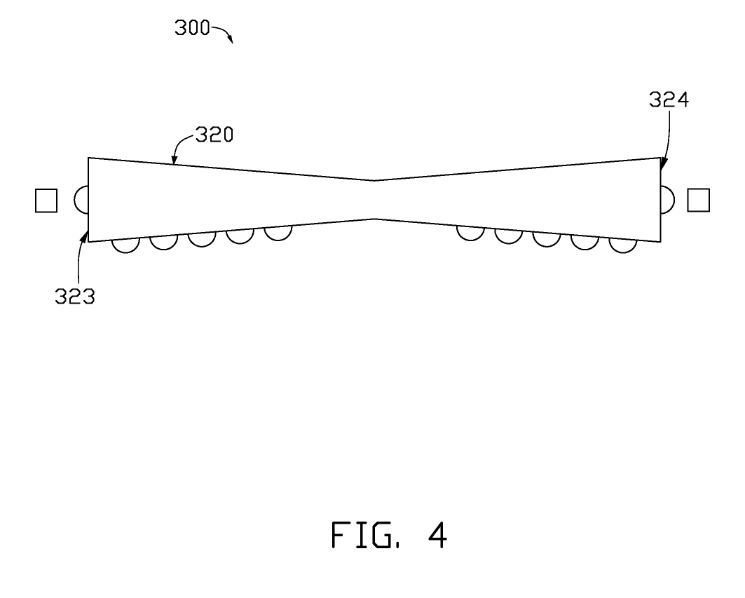

Referring to FIG. 4, an infrared light bar 300, in accordance with a third embodiment, has the similar structure with the infrared light bar 100 of the first embodiment except that the structure of the infrared light guide member 320 is different with that of the infrared light guide member 20 of the first embodiment. In the present embodiment, the infrared light guide member 320 tapers from the first and second end surfaces 323, 324 to a middle portion thereof.

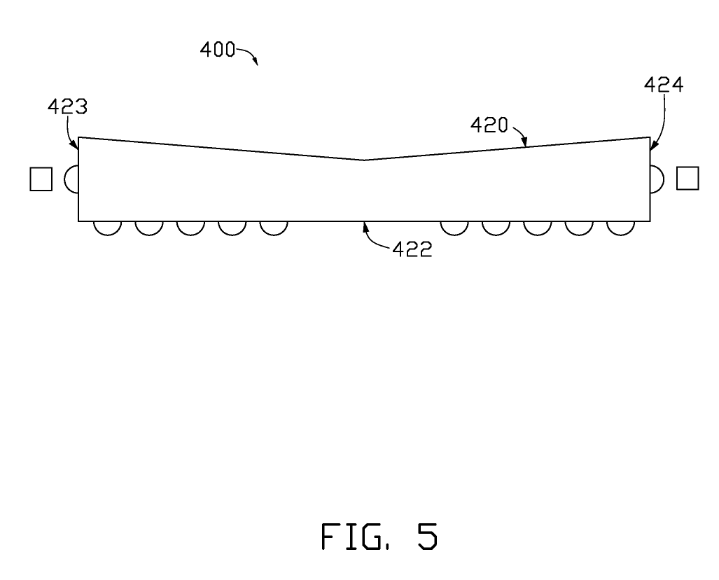

Referring to FIG. 5, an infrared light bar 400, in accordance with a fourth embodiment, has the similar structure with the infrared light bar 300 of the third embodiment except that the structure of the infrared light guide member 420 is different with that of the infrared light guide member 320 of the third embodiment. In the present embodiment, the infrared light guide member 420 tapers from the first and second end surfaces 423, 424 to a middle portion thereof, and the longitudinal side surface 422 is a plane.

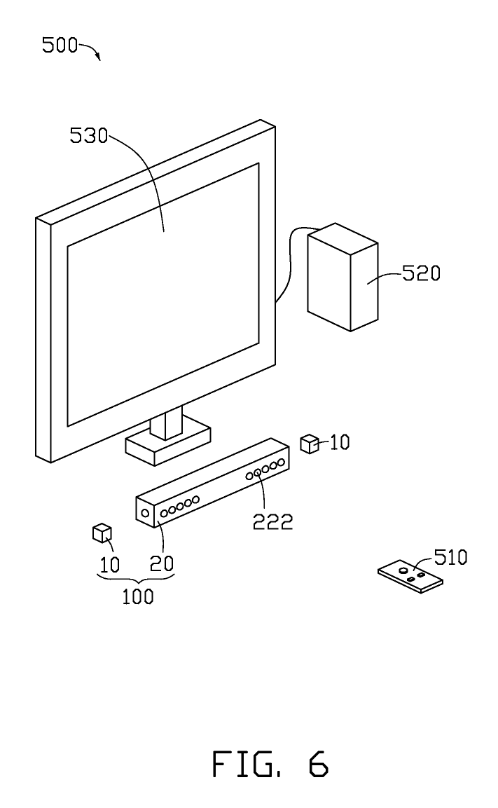

Referring to FIG. 6, a game device 500, in accordance with an exemplary embodiment, includes the infrared light bar 100 of the first embodiment in FIG. 1 and a remote controller 510. The remote controller 510 includes an infrared sensor (not shown) for sensing the infrared light from the infrared light bar 100. The remote controller 510 is configured for determining a location and distance thereof relative to the infrared light bar 100.

The game device 500 further comprises a game console 520 and a display device 530. The game console 520 is electrically connected with the display device 530, and configured for receiving a control signal from the remote controller 510. The game console 520 is configured for processing game data and control signals, and transmitting the processed data and control signals to the display device 530 for display.

The display device 530 is configured for displaying the game pictures transmitted from the game console 520.

The remote controller 510 is operated by a player. The remote controller 510 compares and processes the image data composing of the light beams emitted from the infrared light bar 100 received by the infrared sensor (not shown), locates the action of the player, and sends the signal of the action location by way of wireless communication, such as Bluetooth, to the game console 510. The game console 520 processes the signal and transmits the signal to the display device 530. Therefore, the action of the player can be shown in the display device 530.

The infrared light bar 100 is arranged aligned with the display device 530. When the game device 500 is in use, the infrared light bar 100 is turned on. In the present embodiment, the light sources 10 of the infrared light bar 100 are infrared light emitting diodes. Enlarging the max length of the infrared light guide member 20 can increase the range of the location, and adding the number of the exposed portions 222 can increase the location precision of the remote controller 51 0. In the present embodiment, the exposed portions 222 are divided into two groups, and are symmetrically arranged on the two ends of the infrared light guide member 20.

The infrared light bar 100 of the present embodiments use only one or two light sources to form a plurality of point light sources, so to reduce the cost of the production.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. An infrared light bar comprising:
at least one light source for emitting infrared light;
an elongated infrared light guide member, the infrared light guide member comprising at least one light incident surface for receiving the infrared light and a longitudinal side surface consisting of a covered portion and a plurality of exposed portions; and
a reflecting layer formed on the entire covered portion of the longitudinal side surface for blocking the infrared light transmitting therethrough, the reflecting layer defining a plurality of spaced openings spatially corresponding to the exposed portions for allowing the infrared light to exit therefrom.

2. The infrared light bar of claim 1, wherein the infrared light guide member comprises a first end surface and an opposing second end surface, and the longitudinal side surface is connected between the first and second end surfaces.

3. The infrared light bar of claim 2, wherein the first end surface is the light incident surface, and the infrared light guide member tapers from the second end surface to the first end surface.

4. The infrared light bar of claim 2, wherein the at least one light source includes two light sources disposed at opposite sides of the infrared light guide member, the first and second end surfaces are the light incident surfaces, and the infrared light guide member tapers from the first and second end surfaces to a middle portion thereof.

5. The infrared light bar of claim 1, wherein the at least one light incident surface is differently oriented from the longitudinal side surface.

6. The infrared light bar of claim 1, further comprising a plurality of protrusions formed on the exposed portions of the longitudinal side surface.

7. The infrared light bar of claim 6, wherein the protrusions are hemispherical protrusions.

8. The infrared light bar of claim 6, wherein the protrusions each have a curved surface.

9. A game device comprising:
an infrared light bar as described in claim 1, and
a remote controller including an infrared sensor for sensing the infrared light from the infrared light bar, the remote controller configured for determining a location and distance thereof relative to the infrared light bar.

10. The game device of claim 9, wherein the light source is an infrared light emitting diode.

11. The game device of claim 9, further comprising a game console and a display device, wherein the game console is connected with the display device.

12. The game device of claim 11, wherein the infrared light bar is aligned with the display device.
